(19) United States
(12) Patent Application Publication
(10) Pub. No.: US 2013/0089783 A1
(43) Pub. Date: Apr. 11, 2013

(54) Negative Active Material and Lithium Battery Containing the Negative Active Material

(71) Applicants: Ha-Na Yoo, Yongin-si (KR); Jae-Myung Kim, Yongin-si (KR); So-Ra Lee, Yongin-si (KR); Chang-Su Shin, Yongin-si (KR); Ui-Song Do, Yongin-si (KR); Yu-Jeong Cho, Yongin-si (KR); Su-Kyung Lee, Yongin-si (KR); Sang-Eun Park, Yongin-si (KR)

(72) Inventors: Ha-Na Yoo, Yongin-si (KR); Jae-Myung Kim, Yongin-si (KR); So-Ra Lee, Yongin-si (KR); Chang-Su Shin, Yongin-si (KR); Ui-Song Do, Yongin-si (KR); Yu-Jeong Cho, Yongin-si (KR); Su-Kyung Lee, Yongin-si (KR); Sang-Eun Park, Yongin-si (KR)

(21) Appl. No.: 13/551,557

(22) Filed: Jul. 17, 2012

(30) Foreign Application Priority Data
Oct. 5, 2011 (KR) 10-2011-0101438

(51) Int. Cl. H01M 4/583; H01M 4/46; H01M 4/60; H01M 4/62; H01M 4/38; B82Y 30/00

(52) U.S. Cl. 429/213; 429/231.8; 429/217; 429/219; 429/220; 429/223; 977/734

(57) ABSTRACT

A negative active material and a lithium battery including the same are disclosed. Due to the inclusion of silicon nanowires formed on a spherical carbonaceous base material, the negative active material may increase the capacity and cycle lifespan characteristics of the lithium battery.

### RELATED APPLICATIONS

This application claims priority to and the benefit of Korean Patent Application No. 10-2011-0101438, filed on Oct. 5, 2011 in the Korean Intellectual Property Office, the entire content of which is incorporated herein by reference.

### BACKGROUND

1. Technical Field

One or more embodiments of the present invention relate to a negative active material and a lithium battery including the negative active material.

2. Description of the Related Art

Lithium secondary batteries used in portable electronic devices for information communication, such as PDAs, mobile phones, or notebook computers, electric bicycles, electric vehicles, or the like, have discharge voltages that are at least twice as high as that of conventional batteries. Thus, lithium secondary batteries have high energy density.

Lithium secondary batteries generate electric energy by oxidation and reduction reactions occurring when lithium ions are intercalated into and deintercalated from a positive electrode and a negative electrode. Each of the positive and negative electrodes include an active material that enables intercalation and deintercalation of lithium ions, and an organic electrolytic solution or a polymer electrolytic solution is positioned between the positive electrode and the negative electrode.

Examples of positive active materials for lithium secondary batteries include oxides that include lithium and a transition metal and that have structures enabling intercalation of lithium ions. Examples of such an oxide include lithium cobalt oxide (LiCoO₂), lithium nickel oxide (LiNiO₂), lithium nickel cobalt manganese oxide (Li[NiCoMn]O₂ or Li[Ni_{1-x-y}CoₓM_{y}]O₂), etc.

Examples of negative active materials include carbonaceous base materials and non-carbonaceous base materials which enable intercalation or deintercalation of lithium ions, and studies have been continuously performed on these materials. Examples of carbonaceous base materials include artificial and natural graphite, and hard carbon. An example of a non-carbonaceous base material is Si.

Some non-carbonaceous base materials have high capacity, which can be 10 times greater than that of graphite. However, due to volumetric expansion and contraction during charging and discharging, the capacity retention ratio, charge/discharge efficiency, and lifetime characteristics thereof may be degraded.

### SUMMARY

One or more embodiments of the present invention include a negative active material with improved lifespan characteristics.

One or more embodiments of the present invention include a lithium battery including the negative active material.

Additional aspects will be set forth in part in the description which follows and, in part, will be apparent from the description, or may be learned by practice of the disclosed embodiments.

According to one or more embodiments of the present invention, a negative active material includes: a primary particle including a spherical carbonaceous base material and silicon-based nanowires disposed on the carbonaceous base material, where a circularity of the carbonaceous base material is about 0.7 to about 1.0.

According to an embodiment of the present invention, the circularity of the carbonaceous base material may be about 0.7 to about 1.0, and for example, about 0.8 to about 1.0, or about 0.9 to about 1.0.

According to an embodiment of the present invention, the carbonaceous base material has pores therein, and a porosity thereof is about 5 to about 30% based on a total volume of the carbonaceous base material.

According to an embodiment of the present invention, the carbonaceous base material may include a crystalline carbonaceous material. For example, the crystalline carbonaceous material may include at least one of natural graphite, artificial graphite, expandable graphite, graphene, carbon black, and fullerene soot.

According to an embodiment of the present invention, an average particle diameter of the carbonaceous base material may be about 1 to about 30 μm.

According to an embodiment of the present invention, the silicon-based nanowires may include at least one of Si, SiOx (0<x≦2), and Si—Z alloys (where Z is an alkali metal, an alkali earth metal, a Group 13 element, a Group 14 element, a transition metal, a rare earth element, or a combination thereof, and is not Si).

According to an embodiment of the present invention, the silicon-based nanowires may be Si nanowires.

According to an embodiment of the present invention, the silicon-based nanowires have an average diameter of about 10 to about 500 nm and an average length of about 0.1 to about 100 μm.

According to an embodiment of the present invention, the silicon-based nanowires may be grown directly on the carbonaceous base material, and the silicon-based nanowires may be grown in the presence or absence of at least one metal catalyst selected from Pt, Fe, Ni, Co, Au, Ag, Cu, Zn, and Cd.

According to an embodiment of the present invention, in the primary particle, an amount of the carbonaceous base material may be about 60 to about 99 wt %, and an amount of the silicon-based nanowires is about 1 to about 40 wt %.

According to an embodiment of the present invention, the negative active material may further include a carbonaceous particle including at least one of natural graphite, artificial graphite, expandable graphite, graphene, carbon black, fullerene soot, carbon nanotubes, or carbon fiber. In this regard, the carbonaceous particle may be in a spherical, planar, fibrous, tubular, or powder form.

According to one or more embodiments of the present invention, a lithium battery includes: a negative electrode including the negative active material described above and a binder; a positive electrode facing the negative electrode; and an electrolyte disposed between the negative electrode and the positive electrode.

The negative active material included in the negative electrode is the same as described above.

According to an embodiment of the present invention, the binder may include at least one of polyvinylidenefluoride, polyvinylidenechloride, polybenzimidazole, polyimide, polyvinylacetate, polyacrylonitrile, polyvinylalcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile-butadiene-styrene, phenol resin, epoxy resin, polyethylene terephthalate, polytetrafluoroethylene, polyphenylsulfide, polyamideimide, polyetherimide, polyethylenesulfone, polyamide, polyacetal, polyphenyleneoxide, polybutylene terephthalate, ethylene-propylene-diene terpolymer (EPDM), sulfonated EPDM, styrene butadiene rubber, and fluoride rubber. For example, an amount of the binder may be about 1 to about 50 parts by weight based on 100 parts by weight of the negative active material.

According to an embodiment of the present invention, the negative electrode may further include at least one conductive agent selected from carbon black, acetylene black, ketjen black, carbon fiber, copper, nickel, aluminum, silver, and conductive polymers.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a schematic view of a lithium battery according to an embodiment of the present invention;

FIG. 2 is a field emission scanning electron microscope (FE-SEM) image of the negative active material of Example 1, depicting the cross-sections of the spherical graphite particles of the base material of the negative active material;

FIGS. 3A and 3B are FE-SEM images of the negative active material of the coin cell manufactured according to Example 1 at different magnifications (FIG. 3A shows 500× magnification and FIG. 3B shows 5000× magnification);

FIGS. 4A and 4B are FE-SEM images of the negative active material of the coin cell manufactured according to Comparative Example 1 at different magnifications (FIG. 4A shows 500× magnification and FIG. 4B shows 5000× magnification);

FIG. 5 is a graph comparing the particle size distribution measurements of the negative active materials of the coin cells manufactured according to Example 1 and Comparative Example 1;

FIG. 6 is an X-ray diffraction pattern of the negative active material of the coin cell of Example 1 measured using a CuKα ray;

FIG. 7 is an X-ray diffraction pattern of the negative active material of the coin cell of Comparative Example 1 measured using a CuKα ray;

FIG. 8 is a graph comparing the volumetric expansion ratios of the negative electrodes of the coin cells manufactured according to Examples 1-3 and Comparative Example 1;

FIG. 9 is a graph comparing the charge-discharge efficiency (CDE) of the coin cells of Example 1 and Comparative Example 1;

FIG. 10 is a graph comparing the capacity retention ratios (CRRs) of the coin cells of Example 1 and Comparative Example 1;

FIG. 11 is a graph comparing the charge-discharge capacities of the coin cells of Example 1 and Comparative Example 1;

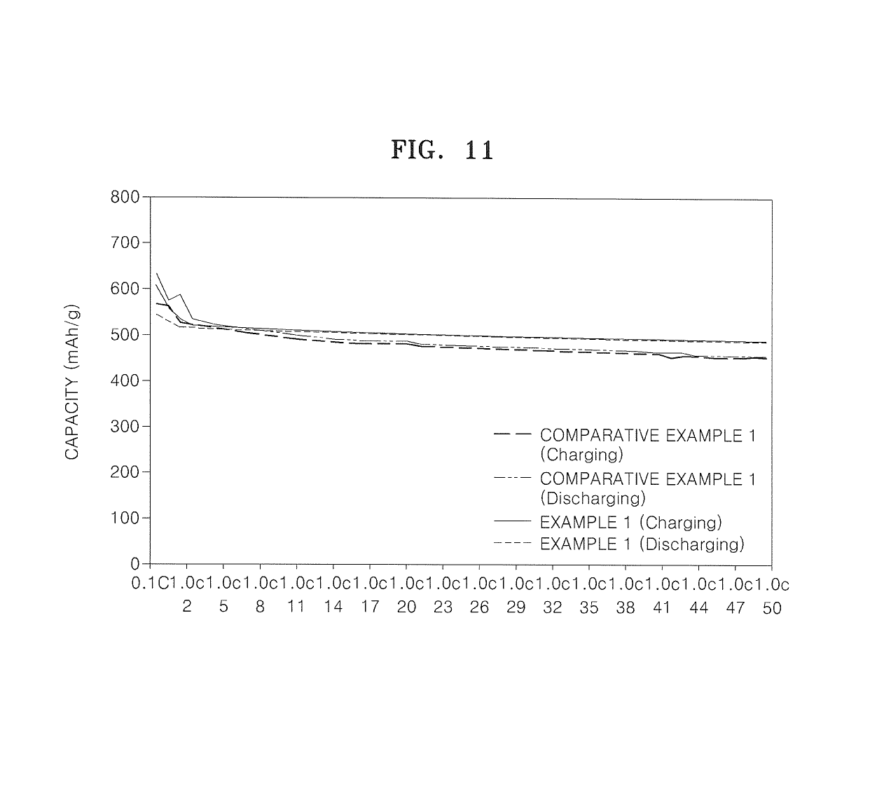

FIG. 12 is a graph comparing the charge-discharge efficiencies (CDEs) of the coin cells manufactured according to Examples 1 to 3;

FIG. 13 is a graph comparing the capacity retention ratios (CRRs) of the coin cells of Examples 1 to 3; and

FIG. 14 is a graph comparing the charge-discharge capacities of the coin cells of Examples 1 to 3.

### DETAILED DESCRIPTION

Reference will now be made in detail to certain embodiments, examples of which are illustrated in the accompanying drawings, wherein like reference numerals refer to like elements throughout. In this regard, the presently described embodiments may modified in different ways and should not be construed as being limited to the descriptions set forth herein. Accordingly, the embodiments are described below, with reference to the figures, to explain certain aspects of the present description.

Expressions such as “at least one of,” when preceding a list of elements, modify the entire list of elements and do not modify the individual elements of the list.

A negative active material according to an embodiment of the present invention includes a primary particle, including a spherical carbonaceous base material and silicon-based nanowires disposed on the carbonaceous base material, where a circularity of the carbonaceous base material is about 0.7 to about 1.0.

The carbonaceous base material may be spherical, and the term “spherical,” as used herein, means that at least a portion of the carbonaceous base material may have a gently or sharply curved external shape. The carbonaceous base material may have a completely spherical shape, or may have an incompletely spherical shape, or may have an oval shape. The carbonaceous base material may also have an uneven surface.

The degree of roundness of the carbonaceous base material may be confirmed by measuring the circularity thereof. As used herein, “circularity” refers to a measured value of how much the measured shape differs from a complete circle, and the value can range from 0 to 1. Thus, if the circularity is closer to 1, the measured shape is more circular. According to an embodiment of the present invention, the circularity of the carbonaceous base material may be about 0.7 to about 1, for example, about 0.8 to about 1, or for example, about 0.9 to about 1.

The spherical carbonaceous base material may contribute to determining the shape of the primary particle, and compared to tabular, plate-shaped, or lump-shaped carbonaceous base materials, the presently described carbonaceous base material is not orientated in any particular direction during pressing (press-molding), and is suitable for high-rate discharge characteristics, low-temperature characteristics, or the like. Also, the specific surface area of the carbonaceous base material is reduced, and thus, reactivity with the electrolytic solution is decreased. Thus, a lithium battery using the material has improved cyclic characteristics.

Also, the term “carbonaceous” base material refers to a base material that includes at least about 50 wt % carbon. For example, the carbonaceous base material may include at least about 60 wt %, 70 wt %, 80 wt %, or 90 wt % carbon, or may include 100 wt % carbon alone.

According to an embodiment of the present invention, the carbonaceous base material may include a crystalline carbonaceous material as a carbon component. The crystalline carbonaceous material is not limited as long as lithium ions are reversibly intercalated or deintercalated during charging and discharging. For example, a plane interval (d002) at the (002) X-ray diffraction plane of the crystalline carbonaceous base material may be equal to or greater than 0.333 nm and less than 0.339 nm, for example, equal to or greater than 0.335 nm and less than 0.339 nm, or equal to or greater than 0.337 nm and equal to or less than 0.338 nm.

Nonlimiting examples of the crystalline carbonaceous material include natural graphite, artificial graphite, expandable graphite, graphene, carbon black, fullerene soot, and combinations thereof. Natural graphite is graphite that is naturally formed, and examples thereof include flake graphite, high crystallinity graphite, microcrystalline, cryptocrystalline, amorphous graphite, etc. Artificial graphite is graphite that is artificially synthesized, and is formed by heating amorphous carbon at high temperatures, and examples thereof include primary or electrographite, secondary graphite, graphite fibers, etc. Expandable graphite is graphite that is formed by intercalating a chemical material, such as an acid or an alkali, between graphite layers, followed by heating to swell a vertical layer of the molecular structure. Graphene refers to a single layer of graphite. Carbon black is a crystalline material that has a less regular structure than graphite, and when carbon black is heated at a temperature of about 3,000° C. for a long period of time, the carbon black may turn into graphite. Fullerene soot refers to a carbon mixture including at least 3 wt % of fullerene (which is a polyhedron bundle that consists of 60 or more carbon atoms). The carbonaceous base material may include one of these crystalline carbonaceous materials or a combination of two or more thereof. For example, natural graphite may be used because the assembly density is easily increased when manufacturing the negative electrode.

The crystalline carbonaceous material may be subjected to, for example, a spheroidizing treatment to form a spherical carbonaceous base material. For example, a spherical carbonaceous base material obtained by a spheroidizing treatment of graphite may have a microstructure in which layered graphite may be gently or sharply curved, or may have a microstructure that contains a plurality of gently or sharply curved graphite scales, or a plurality of graphite thin films.

According to an embodiment of the present invention, when the carbonaceous base material is formed in a spherical shape through the spheroidizing treatment, the carbonaceous base material may have a pore or pores therein. The pore(s) present inside the carbonaceous base material may contribute to a decrease in the volumetric expansion of the silicon-based nanowires during charging and discharging. According to an embodiment of the present invention, the carbonaceous base material may have a porosity of about 5 to about 30%, for example, about 10 to about 20%, based on the total volume of the carbonaceous base material.

The average particle size of the carbonaceous base material is not limited. However, if the average particle size of the carbonaceous base material is too small, reactivity with the electrolytic solution is too high, and thus, the cycle characteristics of the resulting lithium battery may be degraded. On the other hand, if the average particle size of the carbonaceous base material is too large, the dispersion stability in preparing the negative electrode slurry is decreased and the resulting negative electrode may have a rough surface. For example, the average particle diameter of the carbonaceous base material may be about 1 to about 30 μm. In some embodiments, for example, the average particle diameter of the carbonaceous base material may be about 5 to about 25 μm, for example, about 10 to about 20 μm.

The carbonaceous base material may function as a support for fixing the silicon-based nanowires, and may also suppress volumetric changes of the silicon-based nanowires during charging and discharging.

The silicon-based nanowires are placed in the carbonaceous base material. In this regard, the term “silicon-based,” as used herein, refers to the inclusion of at least about 50 wt % silicon (Si). For example, the silicon-based nanowires can include at least about 60 wt %, about 70 wt %, about 80 wt %, or about 90 wt % Si, or may include 100 wt % Si alone. Also, in this regard, the term “nanowire,” as used herein, refers to a wire structure having a nano-diameter cross-section. For example, the nanowire may have a cross-section diameter of about 10 to about 500 nm, and a length of about 0.1 to about 100 μm. Also, an aspect ratio (length:width) of each nanowire may be about 10 or more, for example, about 50 or more, or for example, about 100 or more. Also, the diameters of the nanowires may be substantially identical to or different from each other, and from among longer axes of nanowires, at least a portion may be linear, gently or sharply curved, or branched. Such silicon-based nanowires may withstand volumetric changes in the lithium battery due to charging and discharging.

The silicon-based nanowires may include, for example, a material selected from the group consisting of Si, SiOx (0<x≦2), Si-Z alloys (where Z is an alkali metal, an alkali earth metal, a Group 13 element, a Group 14 element, a transition metal, a rare earth element, or a combination thereof, and is not Si), or a combination thereof, but the material for forming the silicon-based nanowires is not limited thereto. The element Z may be selected from Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, Po, and combinations thereof. Also, Si, SiOₓ, and the alloy of Si and Z may include amorphous silicon, crystalline (including single or polycrystalline) silicon, or a combination thereof. The silicon-based nanowires may include these materials alone or in a combination. For example, Si nanowires may be used as the silicon-based nanowires in consideration of high capacity.

The silicon-based nanowires may be manufactured by directly growing silicon-based nanowires on the spherical carbonaceous base material, or by disposing, (for example, attaching or coupling) silicon-based nanowires which have been grown separately to the carbonaceous base material. The silicon-based nanowires may be disposed on the spherical carbonaceous base material using any known placement methods. For example, the nanowires may be grown using a vapor-liquid-solid (VLS) growth method, or using a nano-sized catalyst that thermally decomposes a precursor gas present nearby. The silicon-based nanowires may be directly grown on the carbonaceous base material in the presence or absence of a metal catalyst. Examples of the metal catalyst include Pt, Fe, Ni, Co, Au, Ag, Cu, Zn, Cd, etc.

The primary particle may include the carbonaceous base material in such an amount that high-capacity silicon-based nanowires are sufficiently included, and volumetric changes in the silicon-based nanowires are suppressed. For example, an amount of the carbonaceous base material may be about 60 to about 99 wt %, and an amount of the silicon-based nanowires may be about 1 to about 40 wt %.

The primary particles may agglomerate or otherwise combine with each other to form secondary particles, or may combine with other active components to form secondary particles.

According to an embodiment of the present invention, the negative active material may further include, together with the primary particles, a carbonaceous particle including at least one of natural graphite, artificial graphite, expandable graphite, graphene, carbon black, fullerene soot, carbon nanotubes, or carbon fiber. In this regard, the carbonaceous particle may be included in a spherical, tabular, fibrous, tubular, or powder form. For example, the carbonaceous particle may be added in its natural form (which may be spherical, tabular, fibrous, tubular, or powder form) to the negative active material, or may be subjected to a spheroidizing treatment (as described above with respect to the carbonaceous base material of the primary particles) and then added in the treated form (as a spherical particle) to the negative active material. If the carbonaceous particle is added as a spherical particle, it may be formed of a material that is identical to or different from the carbonaceous base material of the primary particle.

A lithium battery according to an embodiment of the present invention includes a negative electrode including the negative active material; a positive electrode facing the negative electrode; and an electrolyte disposed between the negative electrode and the positive electrode.

The negative electrode may include the negative active material. The negative electrode may be manufactured by various methods. For example, the negative active material, a binder, and selectively, a conductive agent, are mixed in a solvent to prepare a negative active material composition, and then the negative active material composition is molded into a desired shape. Alternatively, the negative active material composition may be applied on a current collector, such as a copper foil or the like.

The binder included in the negative active material composition aids bonding between the negative active material particles and, for example, the conductive agent, and between the negative active material particles and the current collector. An amount of the binder may be about 1 to about 50 parts by weight based on 100 parts by weight of the negative active material. For example, the amount of the binder may be about 1 to about 30 parts by weight, about 1 to about 20 parts by weight, or about 1 to about 15 parts by weight, based on 100 parts by weight of the negative active material. Nonlimiting examples of the binder include polyvinylidenefluoride, polyvinylidenechloride, polybenzimidazole, polyimide, polyvinylacetate, polyacrylonitrile, polyvinylalcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile-butadiene-styrene, phenol resin, epoxy resin, polyethylene terephthalate, polytetrafluoroethylene, polyphenylsulfide, polyamideimide, polyetherimide, polyethylenesulfone, polyamide, polyacetal, polyphenyleneoxide, polybutylene terephthalate, ethylene-propylene-diene terpolymer (EPDM), sulfonated EPDM, styrene butadiene rubber, fluoride rubber, various copolymers, etc., and combinations thereof.

The negative electrode may optionally further include a conductive agent to provide a conductive passage to the negative active material to further improve electrical conductivity. As the conductive agent, any material used in lithium batteries may be used. Nonlimiting examples of the conductive agent include carbonaceous materials, such as carbon black, acetylene black, ketjen black, carbon fiber (for example, a vapor phase growth carbon fiber), or the like; metals, such as copper, nickel, aluminum, silver, or the like, each of which may be used in powder or fiber form; conductive polymers, such as polyphenylene derivatives; and mixtures thereof. The amount of the conductive agent may be appropriately controlled. For example, the conductive agent may be added in such an amount that a weight ratio of the negative active material to the conductive agent is about 99:1 to about 90:10.

The solvent may be N-methylpyrrolidone (NMP), acetone, water, or the like. The amount of the solvent may be about 1 to about 10 parts by weight based on 100 parts by weight of the negative active material. If the amount of the solvent is within this range, the active material layer may be easily formed.

Also, the current collector may have a thickness of about 3 to about 500 μm.

The current collector is not particularly limited as long as the current collector does not cause a chemical change in the battery and is conductive. Nonlimiting examples of materials for the current collector include copper, stainless steel, aluminum, nickel, titanium, calcined carbon, copper and stainless steel surface-treated with carbon, nickel, titanium, silver, or the like, alloys of aluminum and cadmium, etc. Also, an uneven micro-structure may be formed on the surface of the current collector to enhance the binding force with the negative active material. Also, the current collector may be take various forms including a film, a sheet, a foil, a net, a porous structure, a foam structure, a non-woven structure, etc.

The prepared negative active material composition may be directly coated on the current collector to form a negative electrode plate, or may be cast onto a separate support and then separated from the support and laminated on the current collector (such as a copper foil) to obtain the negative electrode plate.

In addition to being useful in the manufacture of a lithium battery, the negative active material composition may be printed on a flexible electrode substrate to manufacture a printable battery.

Separately, to manufacture a positive electrode, a positive active material composition is prepared by mixing a positive active material, a conductive agent, a binder, and a solvent.

As the positive active material, any lithium-containing metal oxide used in conventional lithium batteries may be used. For example, LiCoO₂, LiMnₓO₂ₓ (where x is 1 or 2), LiNi₁₋ₓMnₓO₂ (where 0<x<1), or LiNi_{1-x-y}CoₓMn_{y}O₂ (where 0≦x≦0.5 and 0≦y≦0.5), or the like may be used. For example, a compound that intercalates and/or deintercalates lithium, such as LiMn₂O₄, LiCoO₂, LiNiO₂, LiFeO₂, V₂O₅, TiS, MoS, or the like, may be used as the positive active material.

The conductive agent, the binder, and the solvent used in preparing the positive active material composition may be the same as those included in the negative active material composition. In some cases, a plasticizer may be further added to each of the positive active material composition and the negative active material composition to form pores in the corresponding electrode plate. Amounts of the positive active material, the conductive agent, the binder, and the solvent may be the same as used in conventional lithium batteries.

The positive electrode current collector may have a thickness of about 3 to about 500 μm, and may be any of various current collectors so long as it does not cause a chemical change in the battery and has high conductivity. Nonlimiting examples of the positive electrode current collector include stainless steel, aluminum, nickel, titanium, calcined carbon, and aluminum and stainless steel surface-treated with carbon, nickel, titanium, silver, or the like. The positive electrode current collector may have an uneven micro-structure at its surface to enhance the binding force with the positive active material. Also, the current collector may be used in various forms including a film, a sheet, a foil, a net, a porous structure, a foam structure, a non-woven structure, etc.

The prepared positive active material composition may be directly coated on the positive electrode current collector to form a positive electrode plate, or may be cast onto a separate support, separated from the support and laminated on the positive electrode current collector to obtain the positive electrode plate.

The positive electrode may be separated from the negative electrode by a separator. The separator may be any of various separators typically used in conventional lithium batteries. For example, the separator may include a material that has low resistance to the migration of ions of an electrolyte and good electrolyte-retaining capability. For example, the separator may include a material selected from glass fibers, polyester, Teflon, polyethylene, polypropylene, polytetrafluoroethylene (PTFE), and combinations thereof, each of which may be nonwoven or woven. The separator may have a pore size of about 0.01 to about 10 μm, and a thickness of about 5 to about 300 μm.

A lithium salt-containing non-aqueous based electrolyte includes a non-aqueous electrolyte and a lithium salt. Nonlimiting examples of the non-aqueous electrolyte include non-aqueous electrolytic solutions, organic solid electrolytes, inorganic solid electrolytes, etc.

As the non-aqueous electrolytic solution, a non-protogenic organic solvent may be used, nonlimiting examples of which include N-methyl-2-pyrrolidone, propylene carbonate, ethylene carbonate, butylene carbonate, dimethyl carbonate, diethyl carbonate, gamma-butyloractone, 1,2-dimethoxy ethane, tetrahydrofuran, 2-methyl tetrahydrofuran, dimethylsulfoxide, 1,3-dioxolane, formamide, dimethylformamide, acetonitrile, nitromethane, methyl formic acid, methyl acetic acid, phosphoric acid trimester, trimethoxy methane, dioxolane derivatives, sulfolanes, methyl sulfolanes, 1,3-dimethyl-2-imidazolidinone, propylene carbonate derivatives, tetrahydrofuran derivatives, ethers, methyl propionic acid, ethyl propionic acid, etc.

Nonlimiting examples of the organic solid electrolyte include polyethylene derivatives, polyethylene oxide derivatives, polypropylene oxide derivatives, phosphate ester polymers, polyagitation lysine, polyester sulfide, polyvinyl alcohol, polyfluorinated vinylidene, polymers having an ionic dissociable group, etc.

Nonlimiting examples of the inorganic solid electrolyte include nitrides, halides, and sulfides of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, or the like.

The lithium salt may be any one of various lithium salts conventionally used in lithium batteries. Nonlimiting examples of material that are dissolved in the non-aqueous electrolyte include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, CF₃SO_{2 2}NLi, lithiumchloroborate, lower aliphatic carbonic acid lithium, 4 phenyl boric acid lithium, imide, etc., and combinations thereof.

Lithium batteries may be categorized as lithium ion batteries, lithium ion polymer batteries, or lithium polymer batteries, according to the separator and electrolyte used. Lithium batteries may also be categorized as cylindrical lithium batteries, square-shaped lithium batteries, coin-shaped lithium batteries, or pouch-shaped lithium batteries, according to the shape thereof. Lithium batteries may also be categorized as bulk-type lithium batteries or thin layer-type lithium batteries, according to the size thereof. The lithium batteries may also be primary batteries or secondary batteries.

Methods of manufacturing lithium batteries are known to those of ordinary skill in the art.

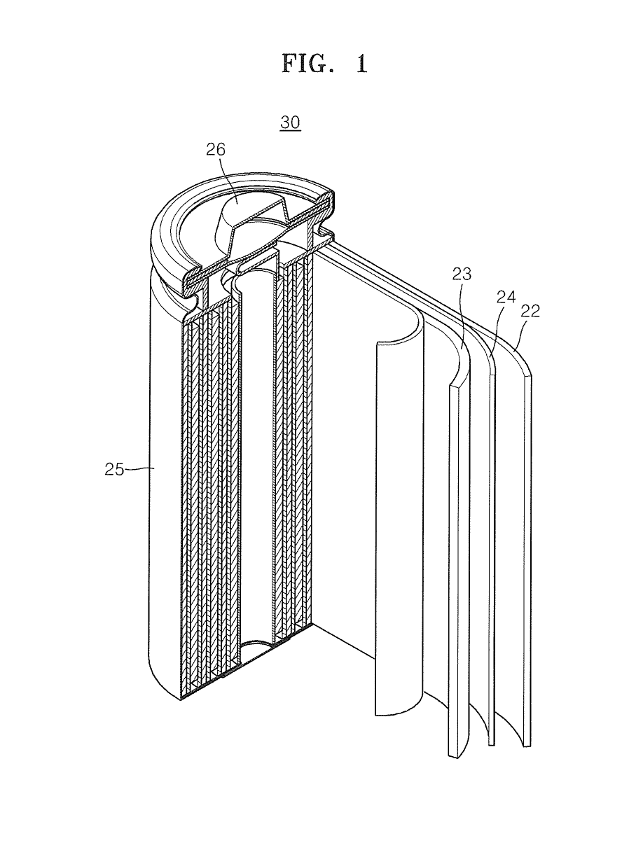

FIG. 1 is a schematic view of a lithium battery 30 according to an embodiment of the present invention. Referring to FIG. 1, the lithium battery 30 includes a positive electrode 23, a negative electrode 22, and a separator 24 between the positive electrode 23 and the negative electrode 22. The positive electrode 23, the negative electrode 22, and the separator 24 are wound or folded and housed in a battery case 25. Then, an electrolyte is injected into the battery case 25, and the battery case 25 is sealed with an encapsulation member 26, thereby completing the manufacture of the lithium battery 30. The battery case 25 may be cylindrical, rectangular, or thin film type. The lithium battery 30 may be a lithium ion battery.

The lithium batteries according to embodiments of the present invention may be used in any application, such as electric vehicles, that require high capacity, high power output, and high-temperature driving. In addition, the lithium batteries according to embodiments of the present invention may be used in mobile phones or portable computers. Also, the lithium batteries may be combined with existing internal-combustion engines, fuel cells, super capacitors, or the like, for use in hybrid vehicles, or the like. Furthermore, the lithium batteries may be used in any other applications that require high power output, high voltage, and high-temperature driving. .

Hereinafter, exemplary embodiments of the present invention will be described in detail with reference to certain examples. However, these examples are presented for illustrative purpose only and do not limit the scope of the present invention.

### Example 1

Si nanowires (SiNWs) were grown on spherical graphite by vapor-liquid-solid (VLS) growth. As the spherical graphite, spherical natural graphite (Hitachi Chemical Company) having an average diameter of about 10 μm was used, and then an Ag catalyst was formed thereon, and SiH₄ gas was provided thereto at a temperature of 500° C. or greater to grow the SiNWs, thereby completing the preparation of the negative active material primary particles. The spherical graphite particles were randomly collected, and then the circularity thereof was measured using a FPIA-3000. The circularity was 0.808 to 1.000. The measured circularity values of the spherical graphite are as follows:

Circularity: 0.808, 0.844, 0.861, 0.878, 0.879, 0.883, 0.884, 0.888, 0.891, 0.892, 0.907, 0.908, 0.913, 0.914, 0.916, 0.918, 0.922, 0.923, 0.924, 0.928, 0.929, 0.934, 0.935, 0.937, 0.938, 0.939, 0.942, 0.943, 0.946, 0.946, 0.947, 0.948, 0.949, 0.952, 0.956, 0.959, 0.961, 0.962, 0.963, 0.963, 0.963, 0.964, 0.964, 0.966, 0.967, 0.967, 0.970, 0.972, 0.976, 0.977, 0.977, 0.977, 0.979, 0.979, 0.982, 0.983, 0.984, 0.986, 0.990, 0.994, 0.995, 0.996, 1.000, 1.000

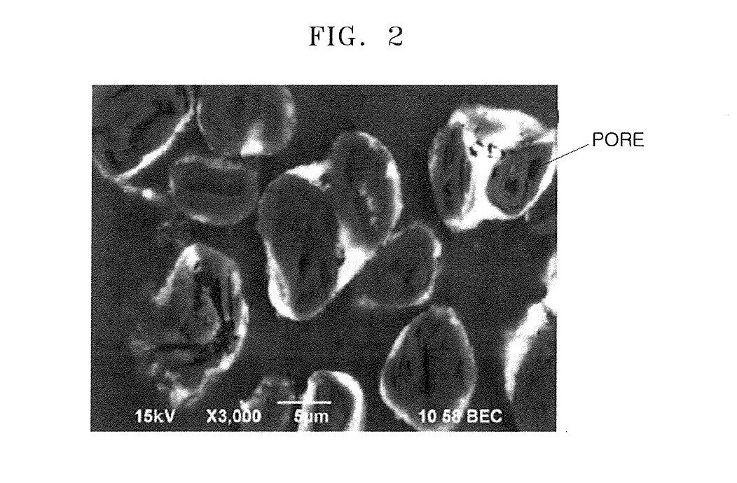

Also, FIG. 2 is a field emission scanning electron microscope (FE-SEM) image of the cross-sections of the spherical graphite particles. As shown in FIG. 2, it was confirmed that pores were formed inside the spherical graphite, and the porosity of the spherical graphite was about 15 vol % based on the total volume thereof. Also, the grown SiNWs had an average diameter of about 30 to about 50 nm, an average length of about 1.5 μm, and the amount of SiNWs was 7.15 wt %.

The prepared negative active material and LSR7 (Hitachi Chemical, a binder that contains 23 wt % of polyamideimide (PAI) and 97 wt % N-methyl-2-pyrrolidone) as a binder were mixed in a weight ratio of 90:10, and then N-methylpyrrolidone was added thereto to control the viscosity thereof until the solids content thereof reached 60 wt %, thereby completing preparation of a negative active material slurry. The prepared slurry was coated on a copper foil current collector having a thickness of 10 μm to manufacture a negative electrode plate. The completely coated electrode plate was dried at a temperature of 120° C. for 15 minutes, followed by pressing, thereby completing the manufacture of a negative electrode having a thickness of 60 μm. Li metal as a reference electrode, and a polyethylene separator having a thickness of 20 μm (product name: STAR20, Asahi) were used, and an electrolyte was injected thereto. The resultant structure was pressed to complete the manufacture of a 2016R type coin cell. The electrolyte was 1.10 M LiPF₆ dissolved in a mixed solvent of ethylene carbonate (EC), ethylmethyl carbonate (EMC), and diethyl carbonate (DEC) at a volumetric ratio of EC:EMC:DEC of 3:3:4.

### Example 2

A coin cell was manufactured in the same manner as Example 1, except that in preparing the negative active material slurry, denka black was further added as a conductive agent in an amount such that a weight ratio of the negative active material and the conductive agent was 96:4.

### Example 3

A coin cell was manufactured in the same manner as Example 1, except that in preparing the negative active material slurry, a vapor growth carbon fiber (VGCF) was further added as a conductive agent in an amount such that a weight ratio of the negative active material and the conductive agent was 92:8.

### Example 4

A negative active material and a coin cell were manufactured in the same manner as Example 1, except that spherical graphite manufactured by Nippon Graphite Industry Company was used to grow the SiNWs. The spherical graphite particles were randomly collected and their circularity was measured. The circularity was 0.778 to 1.000. The measured circularity values of the spherical graphite are as follows.

Circularity: 0.778, 0.791, 0.820, 0.861, 0.865, 0.867, 0.868, 0.884, 0.886, 0.903, 0.907, 0.914, 0.916, 0.916, 0.918, 0.920, 0.921, 0.933, 0.935, 0.937, 0.943, 0.943, 0.950, 0.958, 0.966, 0.967, 0.967, 0.972, 0.972, 0.976, 1.000, 1.000.

The graphite had an average particle size of 17 μm and an interior porosity of 25 vol %.

### Comparative Example 1

A negative active material and a coin cell were manufactured in the same manner as Example 1, except that lump-shaped graphite manufactured by Timcal Company was used to grow the SiNWs. The lump-shaped graphite was planar-shaped, and the circularity thereof was 0.581 to 0.697. The measured circularity values of the lump-shaped graphite are as follows.

Circularity: 0.581, 0.587, 0.616, 0.618, 0.638, 0.643, 0.643, 0.646, 0.647, 0.647, 0.658, 0.659, 0.663, 0.663, 0.663, 0.672, 0.674, 0.677, 0.689, 0.693, 0.694, 0.697, 0.697.

### Comparative Example 2

A negative active material and a coin cell were manufactured in the same manner as Example 1, except that artificial graphite manufactured by Hitachi Chemical Company was used to grow the SiNWs. The artificial graphite was lump-shaped, and the circularity thereof was 0.510 to 0.694. The measured circularity values of the artificial graphite are as follows.

Circularity: 0.510, 0.518, 0.528, 0.537, 0.537, 0.537, 0.571, 0.578, 0.585, 0.602, 0.602, 0.602, 0.602, 0.605, 0.613, 0.622, 0.636, 0.637, 0.644, 0.644, 0.644, 0.644, 0.644, 0.644, 0.644, 0.653, 0.655, 0.663, 0.665, 0.672, 0.674, 0.674, 0.674, 0.676, 0.683, 0.684, 0.684, 0.685, 0.685, 0.685, 0.686, 0.686, 0.689, 0.690, 0.691, 0.692, 0.692, 0.694.

### Negative Active Material Analysis

### Evaluation Examples 1 and 2

### Analysis of FE-SEM Images of Negative Active Materials

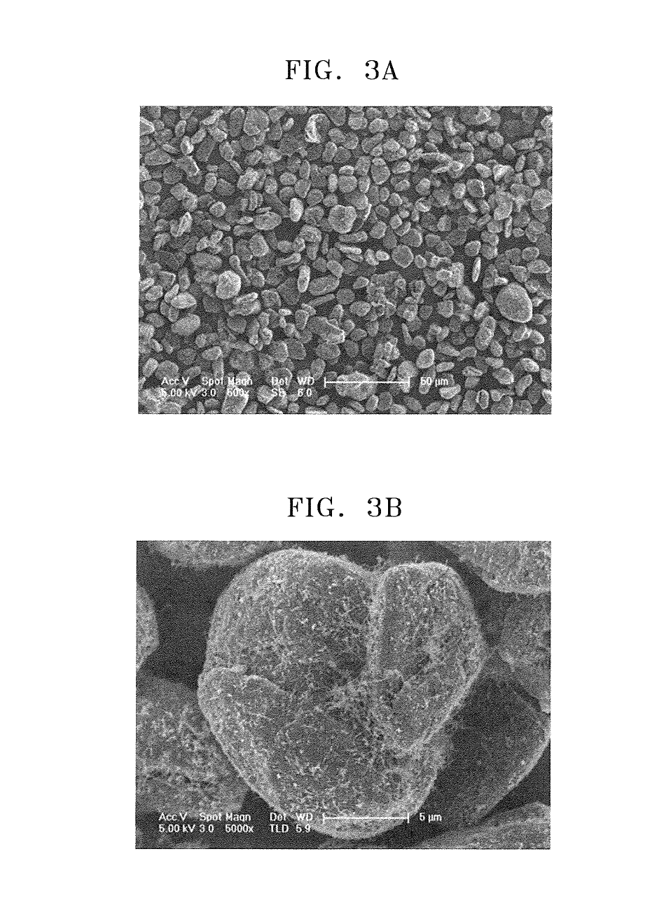

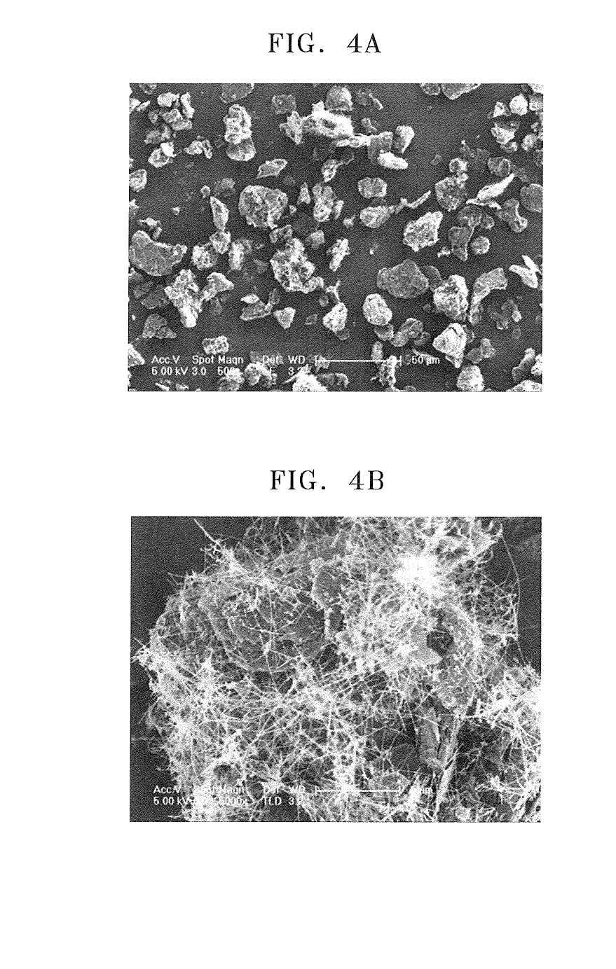

FIGS. 3A-3B, and FIGS. 4A-4B show enlarged FE-SEM images of the negative active materials used in the coin cells manufactured according to Example 1 and Comparative Example 1, respectively.

As shown in FIGS. 3A and 3B, the Si nanowires of the negative active material used in Example 1 were uniformly grown on the spherical graphite. As shown in FIGS. 4A and 4B, the Si nanowires of the negative active material used in Comparative Example 1 were randomly grown on the planar graphite, and thus, the distribution of the Si nanowires was not uniform.

### Evaluation Example 3

### Analysis of Particle Distribution of Negative Active Materials

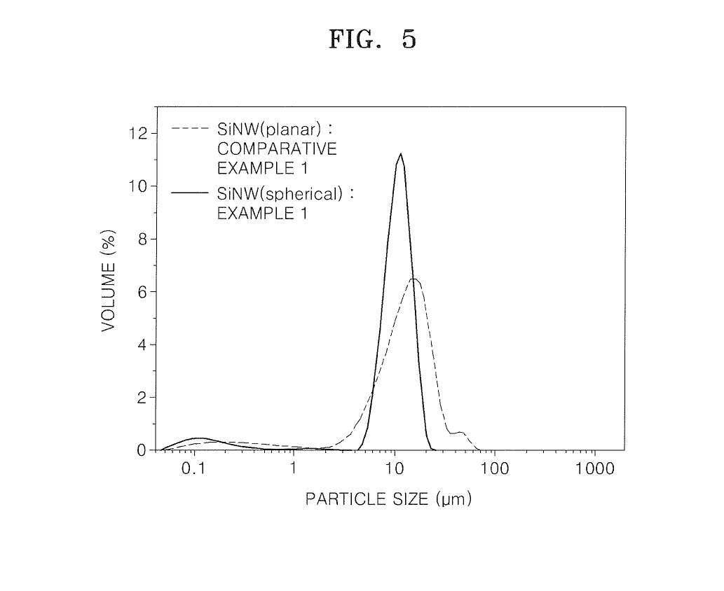

The particle distributions of the negative active materials used in the coin cells of Example 1 and Comparative Example 1 were measured using a particle distribution analyzer (Counter, Beckmann Coulter, Inc.), and the results thereof are shown in Table 1 below and FIG. 5.

TABLE 1

| | Negative active | | | |
|---|---|---|---|---|
| | material | D10 | D50 | D90 |
| Example 1 | SiNW | 6.31 | 10.7 | 15.8 |
| | (spherical) | | | |
| Comparative | SiNW | 6.8 | 14.8 | 26.6 |
| Example 1 | (planar) | 4.27 | 13.2 | 25.1 |

As shown in Table 1 and FIG. 5, the negative active material used in Comparative Example 1 (in which a planar graphite was used as the base material) had a random particle distribution and a wide distribution width. On the other hand, the negative active material used in Example 1 (in which spherical graphite was used as the base material) had a narrow distribution width and a relatively uniform size.

### Evaluation Example 4

### Evaluation of XRD of Negative Active Materials

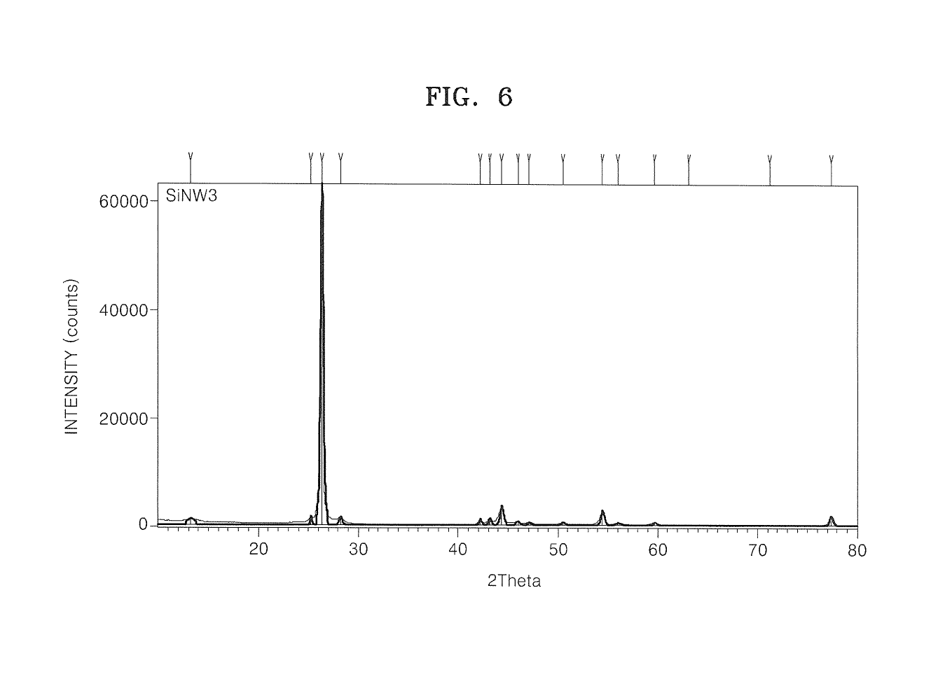

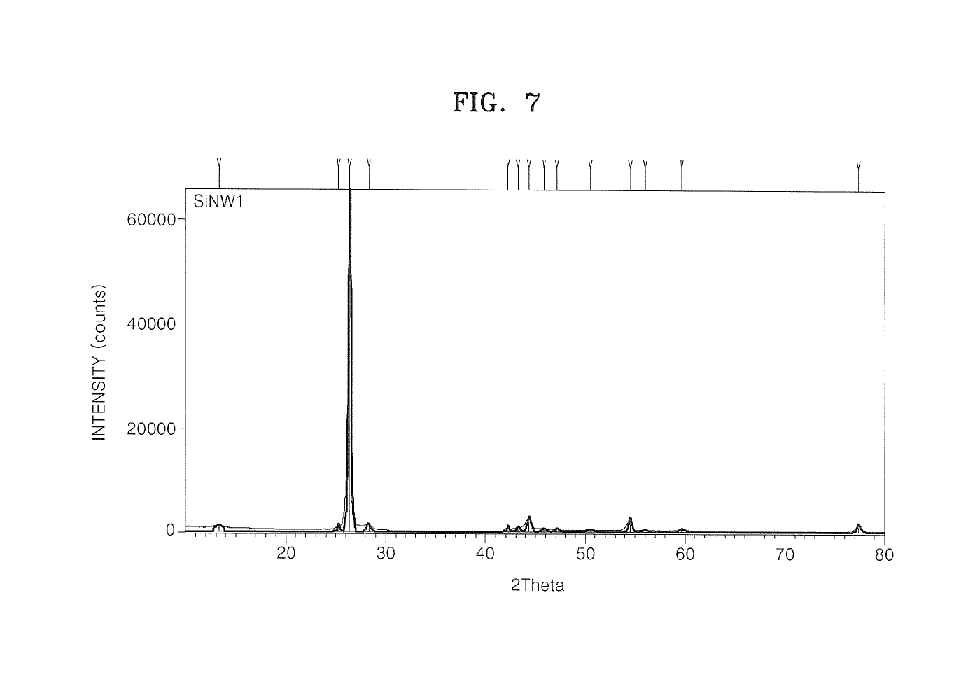

X-ray diffraction patterns of the negative active materials used in the coin cells of Example 1 and Comparative Example 1 were obtained using a CuKα ray, and the results thereof are shown in FIGS. 6 and 7 and Table 2 below.

TABLE 2

| | Negative active | | | | |
|---|---|---|---|---|---|
| | material | Theta | d-spacing | FWHM | T |
| Example 1 | SiNW | 26.3452 | 3.38 | 0.307 | 26.58 |
| | (spherical) | | | | |
| Comparative | SiNW | 26.3782 | 3.37 | 0.2558 | 31.90 |
| Example 1 | (planar) | | | | |

The XRD data shows that the negative active materials of Example 1 and Comparative Example 1 have a crystal structure due to the graphite used as the base material.

### Evaluation of Cell Properties

### Evaluation Example 5

### Electrode Volumetric Expansion Ratio Measurements

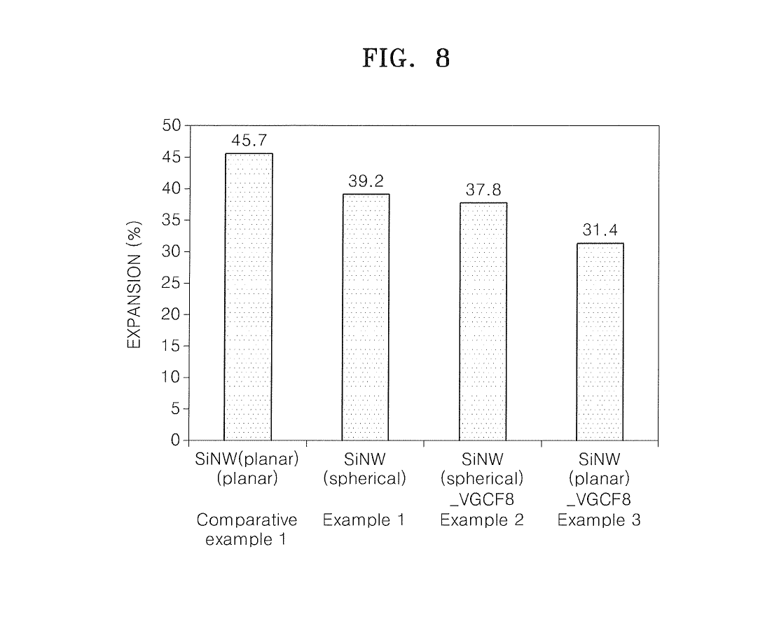

The coin cells of Examples 1-3 and Comparative Example 1 were charged (formation) at a current of 0.05 C, and then the coin cells were disassembled to compare the thickness of the negative electrode plate before and after charging, and the volumetric expansion ratio of the negative electrodes of the coin cells was measured. The results thereof are shown in FIG. 8.

As shown in FIG. 8, when spherical graphite was used as the base material (Examples 1-3), the volumetric expansion ratio of the SiNW negative active materials was reduced as compared to when planar graphite was used as the base material (Comparative Example 1). Also, due to the inclusion of a conductive agent, the decrease in the volumetric expansion ratio was further enhanced.

### Evaluation Example 6

### Charging and Discharging Tests

The coin cells of Examples 1-3 and Comparative Example 1 were charged at a current of 40 mA per 1 g of a negative active material until the voltage reached 0.001 V(vs. Li), and then discharged with the same amplitude of current until the voltage reached 3 V (vs. Li). Then, within the same current and voltage ranges, charging and discharging were repeated 50 times.

This charging and discharging test was performed at room temperature (25° C.). Initial coulombic efficiency (ICE) is defined according to Equation 1 below. Charge-discharge efficiency (CDE) is defined according to Equation 2 below. Capacity retention ratio (CRR) is defined according to Equation 3 below.

ICE [%]=[discharging capacity in the 1^{st} cycle/charging capacity in the 1^{st} cycle]×100 Equation 1

CDE [%]=[discharging capacity in each cycle/charging capacity in the same cycle]×100 Equation 2

CRR [%]=discharging capacity in the 50th cycle/discharging capacity in the first cycle Equation 3

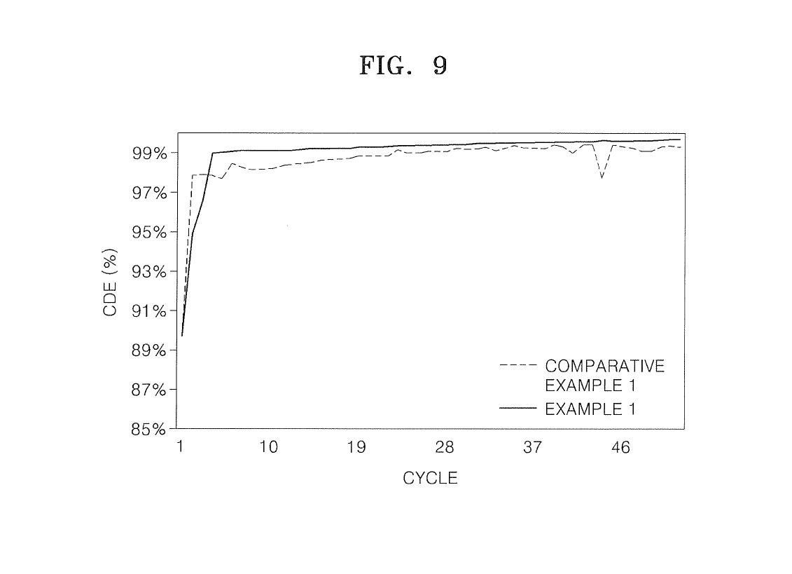

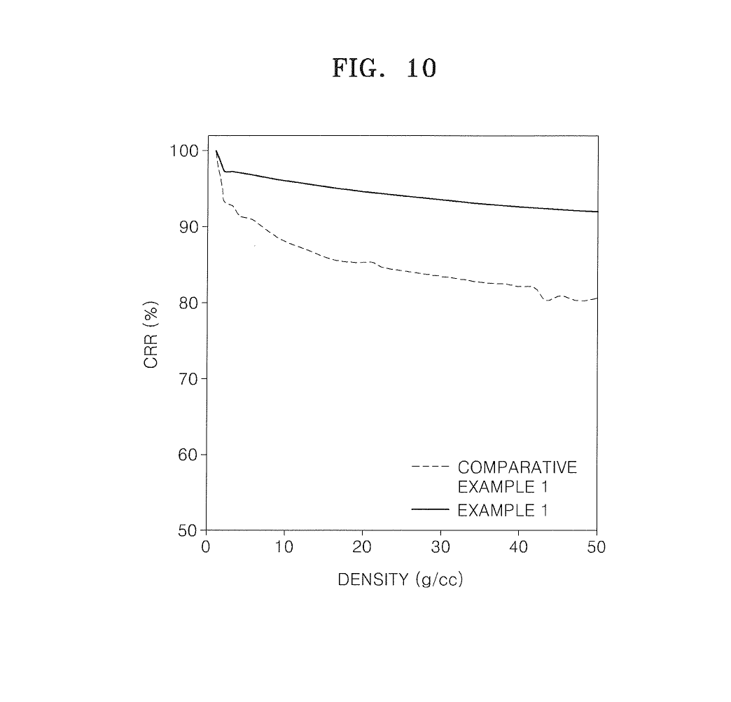

To compare the charge and discharge effect obtained by using spherical graphite as the base material for the SiNW active materials, the CED data of the coin cells of Example 1 and Comparative Example 1 is illustrated in FIG. 9, the CRR data is illustrated in FIG. 10, and the charge-discharge capacity data is illustrated in FIG. Also, the respective data are shown in Table 3 below.

TABLE 3

| | Negative active | Initial capacity (mAh/g) | | | CDE (%): | CRR (%): | Expansion |
|---|---|---|---|---|---|---|---|
| | material | Charging | Discharging | ICE (%) | 50 cycles | 50 cycles | ratio (%) |
| Ex. 1 | SiNW (spherical) | 608 | 546 | 89.7 | 99.7 | 92.0 | 39.2 |
| Comparative | SiNW (planar) | 633 | 567 | 89.7 | 99.3 | 80.4 | 45.7 |
| Ex. 1 | | | | | | | |

As shown in the results above, when spherical graphite was used as the base material (Example 1), the rate characteristics and lifespan characteristics of the SiNW negative active material were improved compared to when planar graphite was used as the base material (Comparative Example 1).

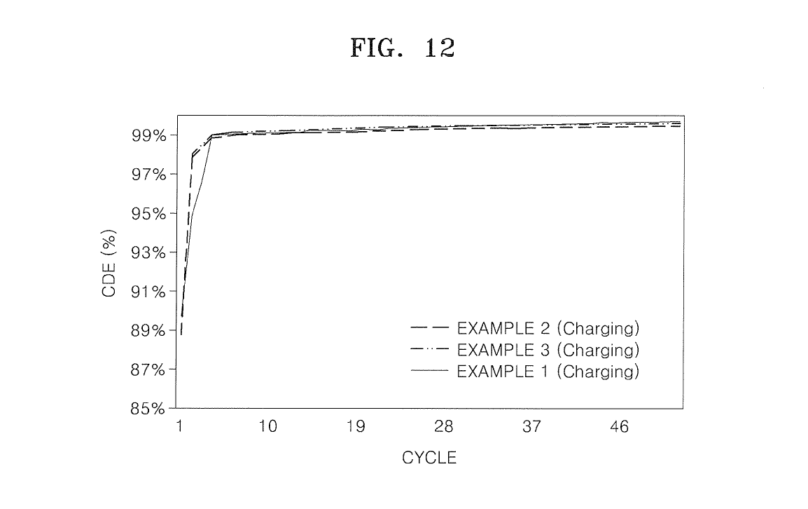

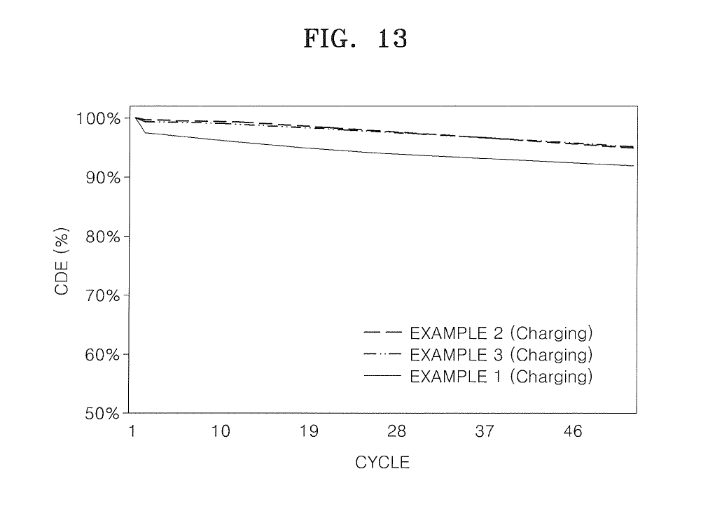

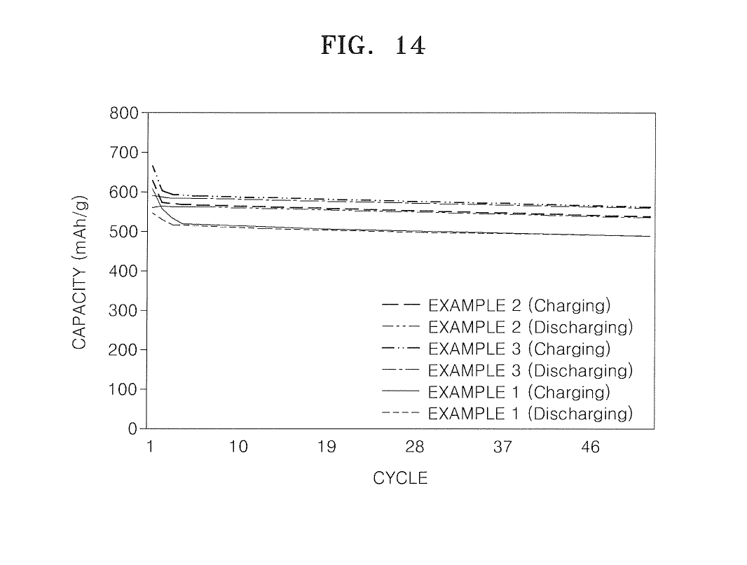

Also, to compare the charge and discharge effect obtained by adding a conductive agent to the SiNW negative active material that uses spherical graphite as the base material, the charge-discharge efficiency (CDE) measurement results of the coin cells of Examples 1-3 are shown in FIG. 12, the capacity retention ratio (CRR) measurement results of the coin cells of Examples 1-3 are shown in FIG. 13, and the charge-discharge capacity measurement results of the coin cells of Examples 1-3 are shown in FIG. 14. Also, the respective data are shown in Table 4 below.

TABLE 4

| | Negative active | Initial capacity (mAh/g) | | | CDE (%): | CRR (%): | Expansion |
|---|---|---|---|---|---|---|---|
| | material | Charge | Discharge | ICE (%) | 50 cycles | 50 cycles | ratio (%) |
| Ex. 1 | SiNW (spherical) | 608 | 546 | 89.7 | 99.7 | 92.0 | 39.2 |
| Ex. 2 | SiNW(spherical) + | 630 | 560 | 88.9 | 99.6 | 95.31 | 37.8 |
| | Denka Black 4% | | | | | | |
| Ex. 3 | SiNW(spherical) + | 666 | 591 | 88.8 | 99.5 | 95.80 | 31.4 |
| | VGCF 8% | | | | | | |

As shown above, it is confirmed that due to the addition of a conductive agent in the SiNW negative active material using spherical graphite as the base material, the rate characteristics and lifespan characteristics of the coin cells were further improved.

As described above, the negative active materials according one or more embodiments of the present invention may compensate for an irreversible capacity loss caused by volumetric expansion/contraction during charging or discharging of a lithium battery, and may improve the cycle lifespan characteristics of the lithium battery.

While certain embodiments have been illustrated and described, those of ordinary skill in the art understand that various modifications can be made to the described embodiments without departing from the spirit and scope of the present invention, as defined by the following claims.

What is claimed is:

1. A negative active material comprising:
a primary particle comprising a substantially spherical carbonaceous base material, the carbonaceous base material having a circularity of about 0.7 to about 1.0, and
silicon-based nanowires on the carbonaceous base material.

2. The negative active material of claim 1, wherein the circularity of the carbonaceous base material is about 0.8 to about 1.0.

3. The negative active material of claim 1, wherein the carbonaceous base material comprises pores and has a porosity of about 5 to about 30% based on a total volume of the carbonaceous base material.

4. The negative active material of claim 1, wherein the carbonaceous base material comprises a crystalline carbonaceous material.

5. The negative active material of claim 4, wherein a plane interval (d002) of a (002) X-ray diffraction plane of the carbonaceous base material is equal to or greater than 0.333 nm and less than 0.339 nm.

6. The negative active material of claim 4, wherein the crystalline carbonaceous material comprises at least one of natural graphite, artificial graphite, expandable graphite, graphene, carbon black, or fullerene soot.

7. The negative active material of claim 1, wherein an average particle diameter of the carbonaceous base material is about 1 to about 30 μm.

8. The negative active material of claim 1, wherein the silicon-based nanowires comprise at least one of Si, SiOx (0<x≦2), or a Si-Z alloy, wherein Z is an alkali metal, an alkali earth metal, a Group 13 element, a Group 14 element, a transition metal, a rare earth element, or a combination thereof, and Z is not Si.

9. The negative active material of claim 1, wherein the silicon-based nanowires comprise Si nanowires.

10. The negative active material of claim 1, wherein the silicon-based nanowires have an average diameter of about 10 to about 500 nm and an average length of about 0.1 to about 100 μm.

11. The negative active material of claim 1, wherein the silicon-based nanowires are grown directly on the carbonaceous base material.

12. The negative active material of claim 11, wherein the silicon-based nanowires are grown in the presence of at least one metal catalyst selected from Pt, Fe, Ni, Co, Au, Ag, Cu, Zn, or Cd.

13. The negative active material of claim 1, wherein an amount of the carbonaceous base material in the primary particle is about 60 to about 99 wt %, and an amount of the silicon-based nanowire is about 1 to about 40 wt %.

14. The negative active material of claim 1, further comprising a carbonaceous particle comprising at least one of natural graphite, artificial graphite, expandable graphite, graphene, carbon black, fullerene soot, carbon nanotubes, or carbon fibers.

15. The negative active material of claim 14, wherein the carbonaceous particle is in a spherical, planar, fibrous, tubular, or powder form.

16. A lithium battery comprising:
a negative electrode comprising the negative active material of claim 1, and a binder;
a positive electrode facing the negative electrode; and
an electrolyte between the negative electrode and the positive electrode.

17. The lithium battery of claim 16, wherein the binder comprises at least one of polyvinylidenefluoride, polyvinylidenechloride, polybenzimidazole, polyimide, polyvinylacetate, polyacrylonitrile, polyvinylalcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile-butadiene-styrene, phenol resin, epoxy resin, polyethylene terephthalate, polytetrafluoroethylene, polyphenylsulfide, polyamideimide, polyetherimide, polyethylenesulfone, polyamide, polyacetal, polyphenyleneoxide, polybutylene terephthalate, ethylene-propylene-diene terpolymer (EPDM), sulfonated EPDM, styrene butadiene rubber, or fluoride rubber.

18. The lithium battery of claim 16, wherein an amount of the binder is about 1 to about 50 parts by weight based on 100 parts by weight of the negative active material.

19. The lithium battery of claim 16, wherein the negative electrode further comprises at least one conductive agent selected from carbon black, acetylene black, ketjen black, carbon fiber, copper, nickel, aluminum, silver, or a conductive polymer.
